(19) United States
(12) Patent Application Publication
(10) Pub. No.: US 2014/0250843 A1
(43) Pub. Date: Sep. 11, 2014

(54) Side Entry Filter

(71) Applicants: Timothy L. Krull, Kearney, NE (US); Michael Von Seggern, Kearney, NE (US); Jeffrey E.D. Rogers, Kearney, NE (US); Steven J. Merritt, Kearney, NE (US)

(72) Inventors: Timothy L. Krull, Kearney, NE (US); Michael Von Seggern, Kearney, NE (US); Jeffrey E.D. Rogers, Kearney, NE (US); Steven J. Merritt, Kearney, NE (US)

(73) Assignee: BALDWIN FILTERS, INC., Kearney, NE (US)

(21) Appl. No.: 14/179,819

(22) Filed: Feb. 13, 2014

Related U.S. Application Data
(60) Provisional application No. 61/775,898, filed on Mar. 11, 2013.

(51) Int. Cl. B01D 46/00

(52) U.S. Cl. CPC B01D 46/0005
USPC 55/357; 29/402.08

(57) ABSTRACT

A filter assembly, filter element, and methods associated therewith are provided. The filter assembly includes a housing and a primary element situated within the housing. The primary filter element is insertable into the housing along a first direction. The primary filter element includes a biasing arrangement for biasing the primary filter element in a second direction transverse to the first direction to form a seal within the housing.

### CROSS-REFERENCE TO RELATED PATENT APPLICATIONS

This patent application claims the benefit of U.S. Provisional Patent Application No. 61/775,898, filed Mar. 11, 2013, the entire teachings and disclosure of which are incorporated herein by reference thereto.

### FIELD OF THE INVENTION

This invention generally relates to filters, and more particularly to side entry filter assemblies, wherein a filter element is inserted into a housing in a direction transverse to a flow path of the housing.

### BACKGROUND OF THE INVENTION

Filtration assemblies are used in a variety of applications including but not limited to automotive, aerospace, industrial facility, and chemical processing applications. Exemplary uses of such assemblies may include air cleaning and/or purification. A common theme in the design of such systems is that a replaceable filter element is situated within an interior of a housing of the filter assembly. The interior of the housing is typically accessible through an access door or covering so that the filter element may be replaced at various intervals.

Typically, the filter element and/or housing includes a sealing arrangement that prevents the fluid that will be filtered from short-circuiting the filter element in operation. Such sealing arrangements can include a radial seal configuration and/or an axial seal configuration. With either type of seal arrangement, a seal of the sealing arrangement must be biased into firm contact with a seat to ensure a firm seal. To accomplish this, conventional housing designs often times incorporate an access door that, when closing the same, biases the filter element contained within the interior of the housing into its required sealing contact with the housing to ensure a good seal. As such, the access door itself provides a mechanical advantage for biasing the filter element into good sealing contact with the housing.

Unfortunately, the operating environments of such filter assemblies have become more crowded as a result of space saving concerns and other factors. As a result, certain filter assemblies now employ what is referred to as a side entry design. In such a design, the filter element is inserted into the housing in a direction that is transverse, and in many cases perpendicular, to the direction of flow through the filter element and/or the direction in which the filter element must be biased to generate a sealing contact with the housing. Thereafter, the filter element must then be biased into its sealing contact with the housing in direction different from the direction of insertion. In these side entry designs, the access door typically is of little to no assistance in biasing the filter element into sealing contact, unlike prior designs described above.

As a result, an installer must manually attempt to bias the filter element, once situated in the interior of the housing, into sealing contact with a seat therein. Given that certain filter elements can be quite large and cumbersome, and that the space in the interior of the housing once the filter element is installed is quite limited, these side entry filter assemblies can lead to increased difficulty and time to install/replace a filter element thereof. Accordingly, there is a need in the art for a side-entry filter assembly that provides for rapid and ergonomic installation/replacement of its associated filter element.

The invention provides such a filter assembly. These and other advantages of the invention, as well as additional inventive features, will be apparent from the description of the invention provided herein.

### BRIEF SUMMARY OF THE INVENTION

In one aspect, the invention provides a side-entry filter assembly. One embodiment of such an assembly includes a housing defining a flow path extending between an inlet and an outlet of the housing. A primary filter element is positioned along the flow path. The primary filter element includes a first filter media arrangement surrounded by a frame including a seat, and is free of a seal. A secondary filter element is also positioned along the flow path in series with the primary filter element. The secondary filter element includes a second filter media arrangement surrounded by a frame with a seal arrangement formed on the frame of the secondary filter element. The seat of the primary filter element axially seats against the seal arrangement of the secondary filter element such that the seal arrangement of the secondary filter element restricts fluid flow through the housing along the flow path through the primary and secondary filter elements.

In another aspect, the invention provides a side-entry filter assembly. One embodiment of such an assembly includes a housing defining a flow path extending between an inlet and an outlet of the housing. A primary filter element is positioned along the flow path. The primary filter element includes a first filter media arrangement surrounded by a handle support. The handle support includes at least one pivot defining a pivot axis. The primary filter element further includes a handle rotatably connected at the at least one pivot. The handle is pivotable about the pivot axis to place the primary filter element into a locked and an unlocked position. A secondary filter element is also positioned along the flow path in series with the primary filter element. The secondary filter element comprising a second filter media arrangement surrounded by a frame. In the locked positioned, the primary filter element sealingly engages the secondary filter element. In the unlocked position, the primary filter element does not sealingly engage the secondary filter element.

According to this aspect, the primary filter element further comprises a frame which surrounds the first filter media. The frame includes a radially extending flange which defines a seat. The secondary filter element further comprises a frame surrounding the second filter media. The frame of the secondary filter element including a seal arrangement formed thereon. The seat axially engages the seal arrangement in the locked position.

In certain embodiments, about 5 to about 15 pounds of force are required to place the primary filter element in the locked position. A portion of the frame of the primary filter element overlaps a portion of the handle support of the primary filter element, and is secured thereto.

In certain embodiments, the primary filter element is free of a seal. In certain embodiments, the seal arrangement includes a seal extending axially beyond a lower most axial extent of the frame of the secondary filter element. The lower most axial extent of the frame of the secondary filter element is an over-compression limiter which prevents continued axial movement of the primary filter element toward the secondary filter element beyond a maximum position.

According to this aspect, a housing insert may also be provided having a generally horseshoe shape and providing a pair of upwardly facing locking surfaces. The handle includes a pair of locking projections having locking surfaces. The upwardly facing locking surfaces of the housing insert axially engage the locking surfaces of the locking projections in the locked position.

In yet another aspect, the invention provides a filter element for a side-entry filter assembly. An embodiment of such a filter element includes a filter media arrangement and a frame assembly at least partially surrounding the filter media arrangement. The frame assembly includes at least one pivot defining a pivot axis. A handle is pivotably attached to the frame assembly at the at least one pivot. A radially extending flange extends outwardly from the frame assembly. The radially extending flange provides a seat for engaging a portion of an axial seal.

In one embodiment according to this aspect, the frame assembly includes a frame and a handle support. The frame is attached to the filter media arrangement adjacent the axial outlet face thereof such that a portion of the frame extends radially inward and overlaps the axial outlet face. The frame extends radially away from an outer peripheral surface of the filter media arrangement to define an annular channel between the outer peripheral surface of the filter media arrangement and an inner peripheral surface of the frame. The frame assembly further comprises a handle support, wherein a portion of the handle support is disposed within the annular channel.

In certain embodiments, the handle includes a pair of locking projections each of which defines a locking surface disposed below the pivots. In certain embodiments, the frame assembly comprises a handle support, and wherein the pivots extend radially outwardly therefrom, wherein the pair of locking projections further comprise secondary locking surfaces in opposed spaced relation to the locking surface, the secondary locking surfaces disposed above the pivots.

In yet another aspect, the invention provides a filter assembly. An embodiment of such a filter assembly includes a housing defining a flow path extending between an inlet and an outlet of the housing. A primary filter element having a first filter efficiency and free of a seal is positioned within the housing along the flow path. A secondary filter element having a second filter efficiency greater than the first filter efficiency is also positioned within the housing along the flow path. The secondary filter element includes a seal arrangement. A biasing arrangement is provided for biasing the primary filter element into sealing engagement with the seal arrangement of the secondary filter element, and for biasing the primary filter element out of sealing engagement with the seal arrangement of the secondary filter element.

In yet another aspect, the invention provides a method for servicing a side-entry filter assembly. An embodiment of such a method includes removing an existing primary filter element from a housing, and removing an existing secondary filter element from the housing. The method also includes installing a new secondary filter element having a seal arrangement for sealingly engaging the housing. The method also includes installing a new primary filter element having a seat and a biasing arrangement into the housing and biasing the seat, using the biasing arrangement, into axial sealing engagement with the seal arrangement.

In certain embodiments, the step of installing the new secondary element includes inserting the secondary element along a first axis of insertion into the housing, and thereafter moving the secondary filter element along a second axis of insertion perpendicular to the first axis of insertion. The step of installing the new primary filter element includes inserting the primary filter element into the housing along the first axis of insertion axially below the secondary filter element. The step of biasing the seat includes biasing the seat with a handle operably connected to the primary filter element to selectively place the primary filter element in a locked and an unlocked position.

In yet another aspect, the invention provides a method for servicing a side-entry filter assembly. An embodiment of such a method includes installing a primary filter element into a housing, the primary filter element including a frame surrounding a filter media, the frame including a pivot about which a handle is pivotably attached. The method also includes biasing the primary filter element to form a seal within the housing using the handle by rotating the handle about the pivot such that a locking surface of the handle engages a locking surface of the housing.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective exploded view of one embodiment of a filter assembly according to the teachings of the present invention;

FIG. 2 is a perspective view of a primary filter element of the filter assembly of FIG. 1;

FIG. 3 is a perspective cross sectional view of the primary element of FIG. 2;

FIG. 4 is a partial view of the cross section of FIG. 3;

FIG. 5 is a perspective view of a secondary filter element of the filter assembly of FIG. 1;

FIG. 6 is a perspective cross sectional view of the secondary element of FIG. 5;

FIG. 7 is a partial view of the cross section of FIG. 6;

FIG. 8 is another perspective exploded view of the filter assembly of FIG. 1;

FIG. 9 is a side view of the filter assembly of FIG. 1, with the primary element in an unlocked position;

FIG. 10 is a perspective cross section of the filter assembly of FIG. 1, with the primary element in the unlocked position;

FIG. 11 is a partial view of the cross section of FIG. 10;

FIG. 12 is a side view of the filter assembly of FIG. 1, with the primary element in a locked position;

FIG. 13 is a partial cross section of the filter assembly of FIG. 1, with the primary element in the locked position;

FIG. 14 is an alternative embodiment of a sealing arrangement according to the teachings of the present invention;

FIG. 15 is another alternative embodiment of a sealing arrangement according to the teachings of the present invention;

FIG. 16 is another alternative embodiment of a sealing arrangement according to the teachings of the present invention;

FIG. 17 is another alternative embodiment of a sealing arrangement according to the teachings of the present invention;

FIG. 18 is a perspective exploded view of another embodiment of a filter assembly according to the teachings of the present invention;

FIG. 19 is a perspective view of a primary element of the filter assembly of FIG. 18;

FIG. 20 is a perspective cross sectional view of the primary element of FIG. 19;

FIG. 21 is a partial view of the cross section of FIG. 20;

FIG. 22 is a side view of the filter assembly of FIG. 18, with the primary element in an unlocked position;

FIG. 23 is a perspective cross section view of the filter assembly of FIG. 18, with the primary element in the unlocked position;

FIG. 24 is a partial view of the cross section of FIG. 23;

FIG. 25 is a side view of the filter assembly of FIG. 18, with the primary element in a locked position;

FIG. 26 is a partial cross sectional view of the filter assembly of FIG. 18, with the primary element in a locked position.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

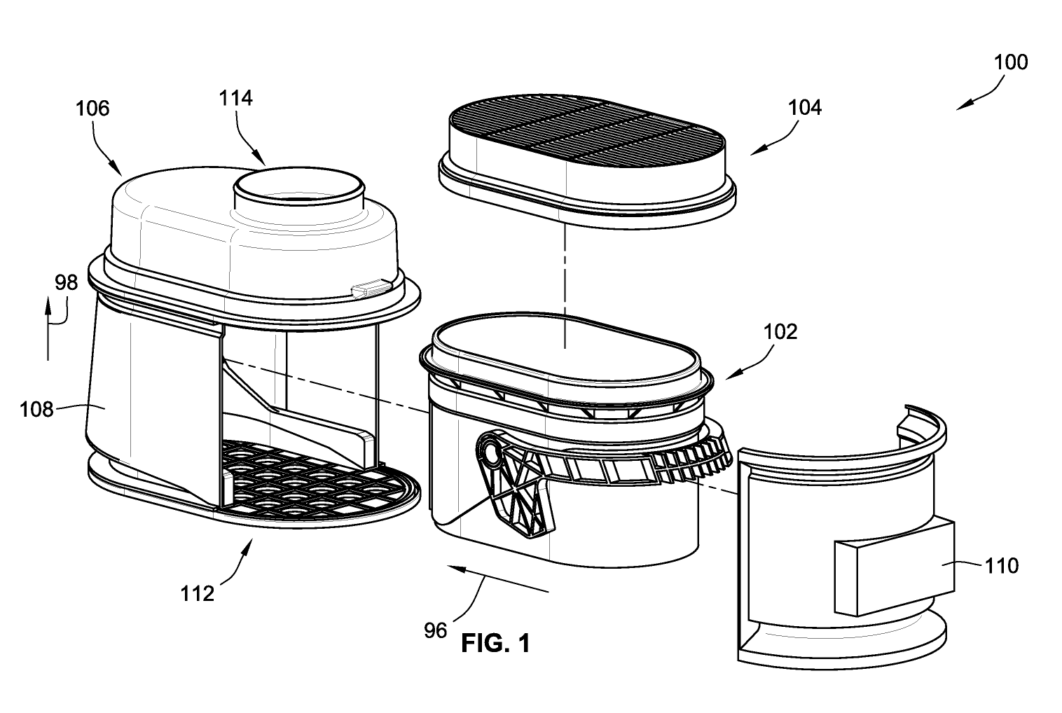

Turning now to the drawings, FIG. 1 illustrates an exemplary embodiment of a filter assembly 100 according to the teachings of the present invention. Filter assembly 100 includes a primary filter element 102 and a secondary filter element 104 each of which are insertable into an interior cavity of a housing 106 along a first direction 96 as shown. More specifically, secondary filter element 104 is first inserted along direction 96 into housing 106, and then inserted along second direction 98 which as illustrated is generally perpendicular to first direction 96. This multi-direction insertion of secondary filter element 104 positions the same along a flow path extending between an inlet 112 and an outlet 114 of housing 106. It will be recognized from the following that the generally compact size of secondary filter element 104 allows for easy insertion along both of directions 96, 98.

Once secondary filter element 104 is adequately positioned within housing 106, and more particularly an interior of a housing body 108 thereof, primary filter element 102 is then inserted into the interior space of housing body 108 along first direction 96. As can be seen from review of FIG. 1, primary filter element 102 is significantly larger than secondary filter element 104. As such, primary filter element 102 advantageously employs a biasing arrangement for biasing primary filter element 102 along second direction 98 to seat primary filter element 102 against a sealing arrangement of secondary filter element 104. Accordingly, and as will be developed more fully herein, filter assembly 100 overcomes existing problems of prior designs by providing a side entry filter configuration that also employs a biasing arrangement to facilitate the ergonomic and quick replacement of either of primary or secondary filter elements 102, 104. Such a configuration advantageously reduces the cost of maintenance of filter assembly 100 as primary and secondary filter elements 102, 104 may be quickly and easily replaced.

Also illustrated in FIG. 1 is an access cover 110 which encloses primary and secondary filter elements 102, 104 within housing body 108 once these elements are installed within the interior space thereof. Once cover 110 is situated on housing body 108, filter assembly 100 will filter a fluid passing between inlet 112 and outlet 114. The dual elements configuration of filter assembly 100 allows for either one of the primary or secondary filter elements 102, 104 to have a higher or lower efficiency than the other of primary or secondary filter elements 102, 104. As one example, primary element 102 may have a lower efficiency and be utilized for coarse filtering of large particles, while secondary filter element 104 may have a higher efficiency and be utilized for fine filtering of smaller particles which have passed through primary filter element 102. The opposite is also true in that primary filter element 102 may have a higher efficiency than secondary filter element 104. To allow for this flexibility, either of filter elements 102, 104 may employ any number of types of filter media to achieve the desired filtering characteristics. As one example, primary filter element 102 may employ fluted filter media, while secondary filter element 104 may employ pleated media. Those skilled in the art will recognize that various other types of suitable filter medias may be employed.

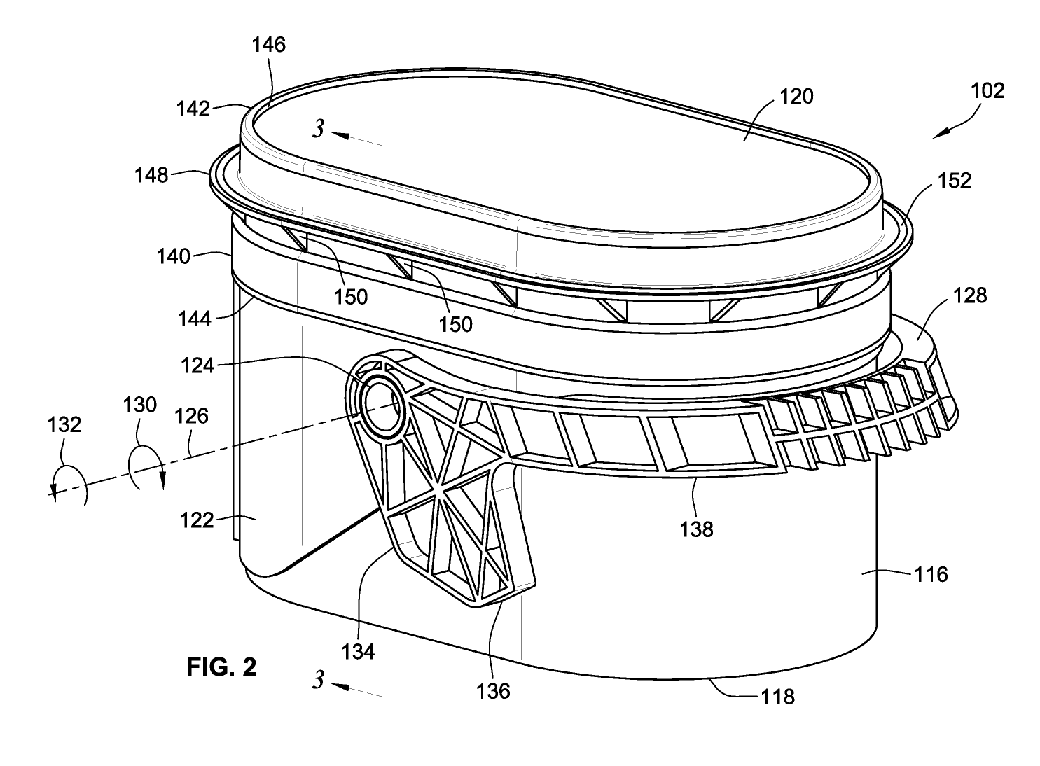

Turning now to FIG. 2, primary filter element 102 will be described in greater detail. Primary filter element 102 includes a block or stack of filter media 116, which as described above may be any type of suitable filter media. Filter media 116 defines an inlet face 118 and an outlet face 120 with a flow path extending through filter media 116 between inlet and outlet faces 118, 120.

A handle support 122 partially or entirely surrounds filter media 116. Handle support 122 provides a pivot 124 radially extending outward from handle support 122 as illustrated. Pivot 124 defines a pivot axis 126 about which a handle 128 is pivotable about in a first rotational direction 130 as well as a second rotational direction 132. As will be explained in greater detail below, handle 128 is operable to bias primary filter element 102 into a locked position such that the same seats against a sealing arrangement of secondary filter element 104. Handle 128 may be designed such that a reduced amount of force is required to bias primary filter element 102 into its locked position by harnessing the mechanical advantage provided by handle 128. As a non-limiting example, to bias primary filter element 102 into a locked position using handle 128, approximately five to fifteen pounds of force may be required.

Handle 128 includes a locking projection 134 which defines a locking surface 136 at an extent of locking projection 134. Although not shown in FIG. 2, a corresponding pivot 124 and locking projection 134 are symmetrically arranged on the other side of primary filter element 102. A connecting portion 138 of handle 128 extends between the locking projections 134 on either side of handle support 122.

Handle 128 may be resiliently attached to pivots 124 through apertures formed in the locking projections 134 as illustrated. Handle support 122 may be secured to filter media 116 through the use of any known adhesive or other bonding technique for bonding a durable material to an exterior of filter media.

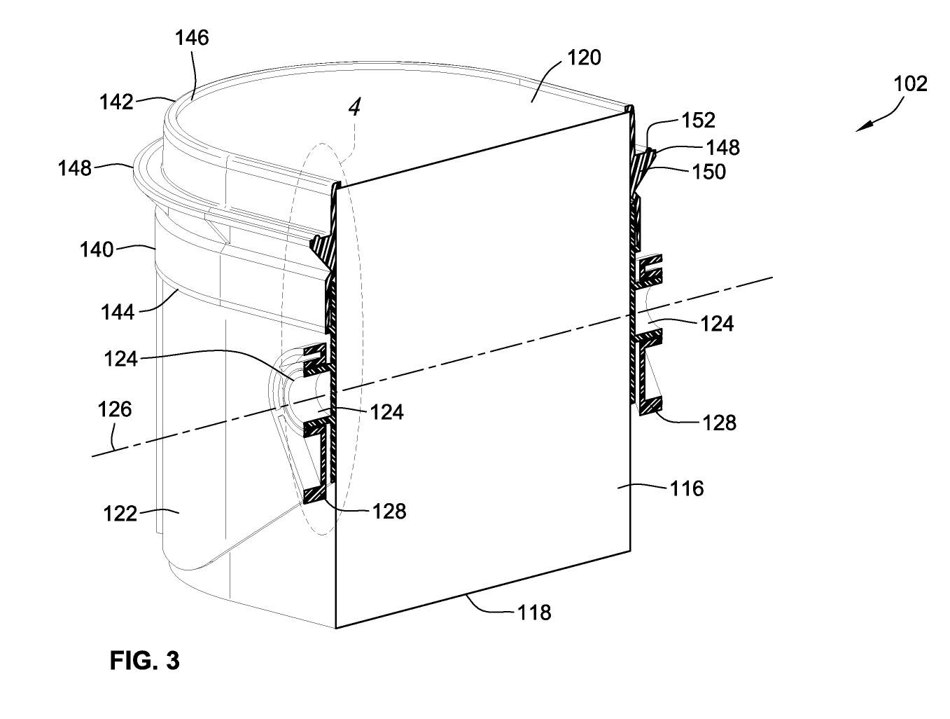

A frame 140 also surrounds filter media 116 proximate the outlet face 120. With reference to FIG. 3, frame 140 extends between an upper-most axial extent 142 and a lower-most axial extent 144. A lip 146 extends radially inward at upper-most axial extent 142 to partially overlap outlet face 120 so as to axially locate frame 140 relative to filter media 116. Frame 140 may be secured to filter media 116 through the use of adhesive or any other known technique for securing a durable material to filter media. Additionally, and as will be described in greater detail below, frame 140, and more particularly lower-most axial extent 144 thereof, may overlap a portion of handle support 122 and be secured thereto.

A plurality of radially projecting supports 150 are positioned beneath a seat 148 of frame 140 for axially supporting the same. As such, frame 140, and more generally primary filter element 102 is free of a seal in that it does not incorporate a seal bead or the like, and instead utilizes a seat 148 which interacts with a seal arrangement 178 of secondary filter element 104. A bead 152 projects axially upward from an upper surface of seat 148. Bead 152 is illustrated as a generally continuous round projection, however, in other embodiments bead 152 may be discontinuous and possess other shapes not limited to that illustrated in FIG. 3.

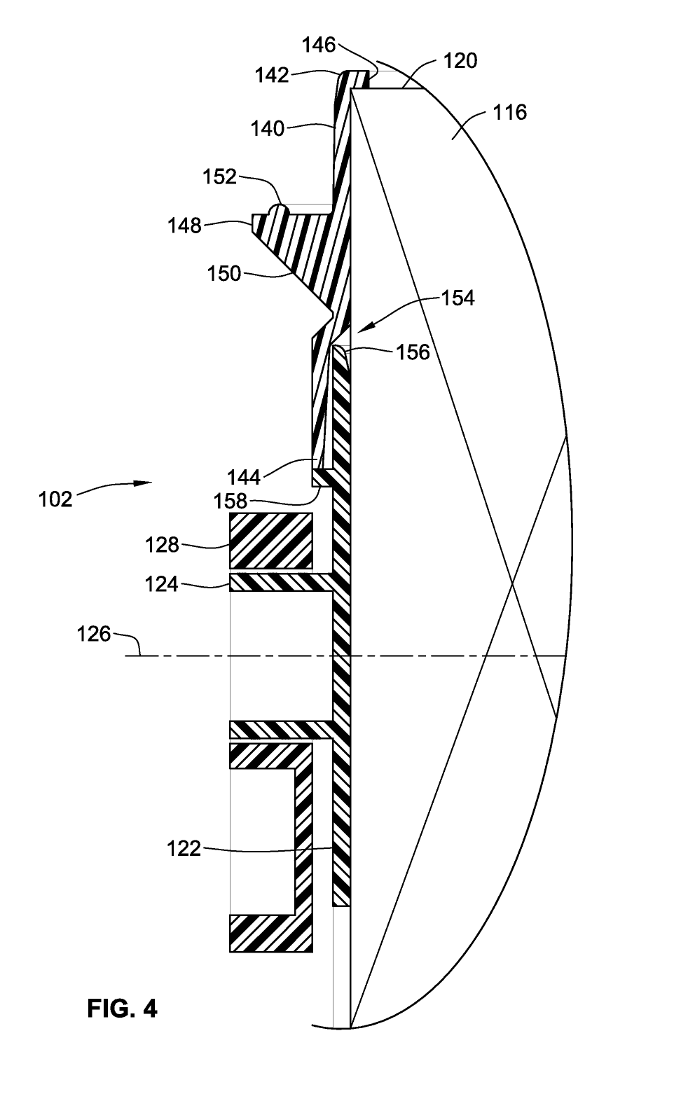

Turning now to FIG. 4, the interrelationship between frame 140, media 116, and handle support 122 is shown in greater detail. As discussed above, frame 140 extends between upper and lower-most axial extents 142, 144. As frame 140 progresses towards lower-most axial extent 144, the same extends radially outward such that an annular channel 154 is formed between a radially outward facing surface of media 116 and a radially inward facing surface of frame 140. An upper-most axial extent 156 of handle support 122 extends into annular channel 154 as shown. A radially outward projecting ledge 158 formed on handle support 122 abuts lower-most axial extent 144 of frame 140 such that annular channel 154 is generally closed. Additional adhesives or the like may be applied within annular channel 154 for positioning frame 140 at its proper location. Further, handle support 122 and frame 140 may be formed as a single component.

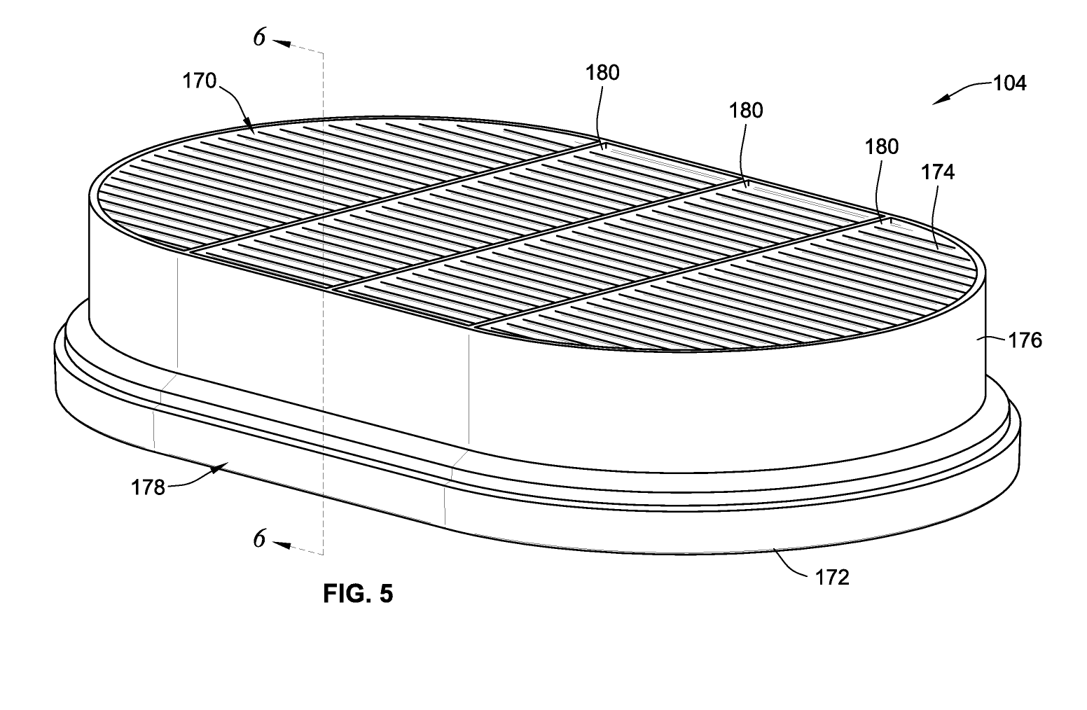

Turning now to FIG. 5, secondary filter element 104 will now be discussed in greater detail. Secondary filter element 104 includes one or more banks of filter media 170. Filter media 170 extends between axially-facing inlet face 172 and an axially-facing outlet face 174. A frame 176 surrounds filter media 170. A seal arrangement 178 is provided on frame 176, and will be described in greater detail below. Frame 176 may also incorporate a plurality of dividers 180 when multiple banks of filter media 170 are used. Alternatively, dividers 180 may be open-sided such that a single bank of filter media 170 extends therethrough.

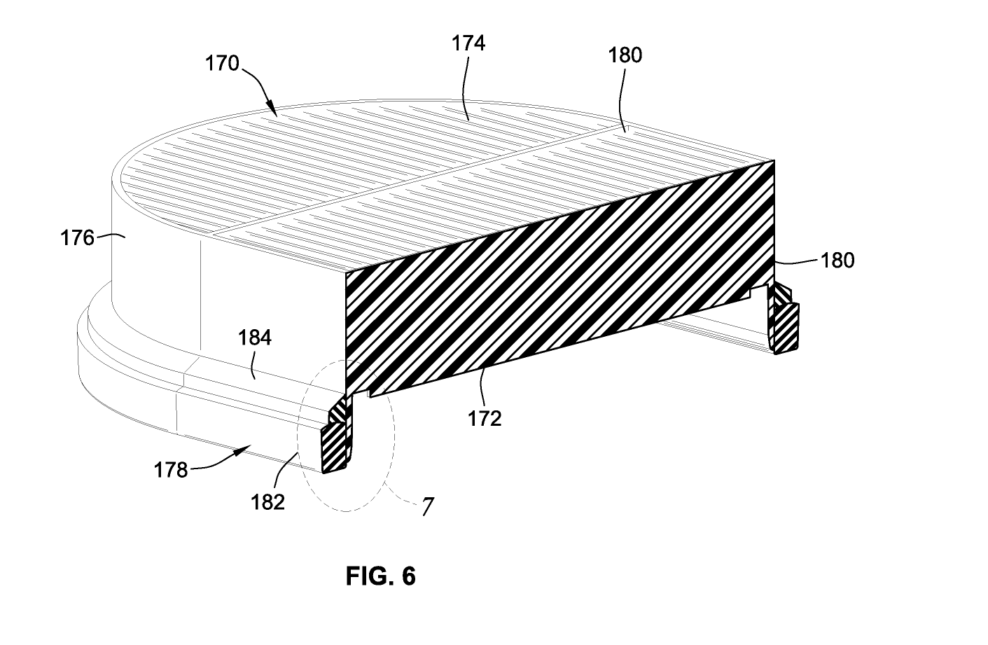

As shown in FIG. 6, seal arrangement 178 includes a seal 182 and a seal support 184. Each of seal 182 and seal support 184 may be formed from a urethane-type material of similar or dissimilar hardness. Additionally, other non-urethane based materials may also be used for seal 182 and seal support 184. In one embodiment, seal support 184 is formed of a harder material than seal 182 such that it will support seal 182 as it is axially compressed.

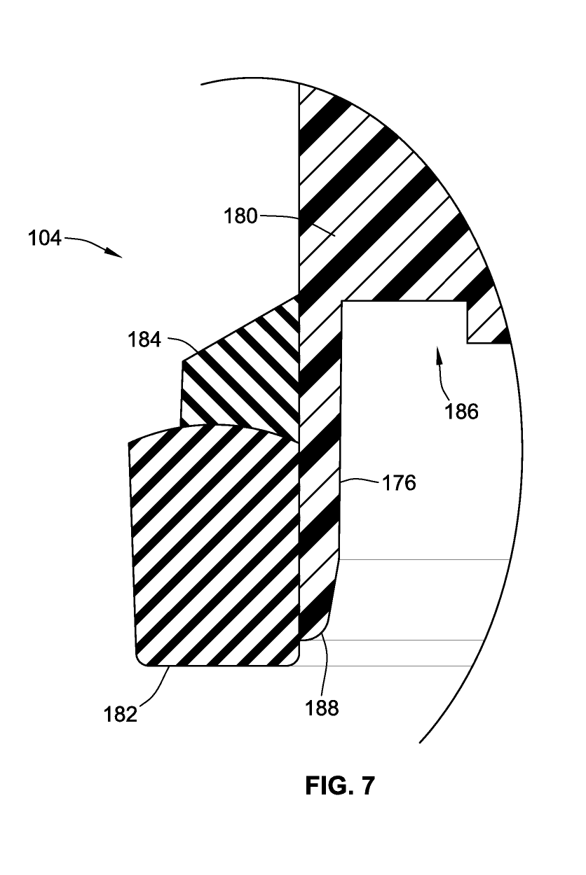

Turning now to FIG. 7, a lower-most axial extent of seal 182 extends axially below a lower-most axial extent 188 of frame 176. In certain embodiments, lower-most axial extent 188 of frame 176 operates as an over-compression limiter for seal 182 such that it will act as a rigid positive stop that will prevent additional compression of seal 182 in the axial direction. Each divider 180 includes a notch 186 formed therein adjacent seal arrangement 178. As will be described in greater detail below, lip 146 (See FIG. 4) projects into notch 186 when secondary filter element 104 is sealed against primary filter element 102.

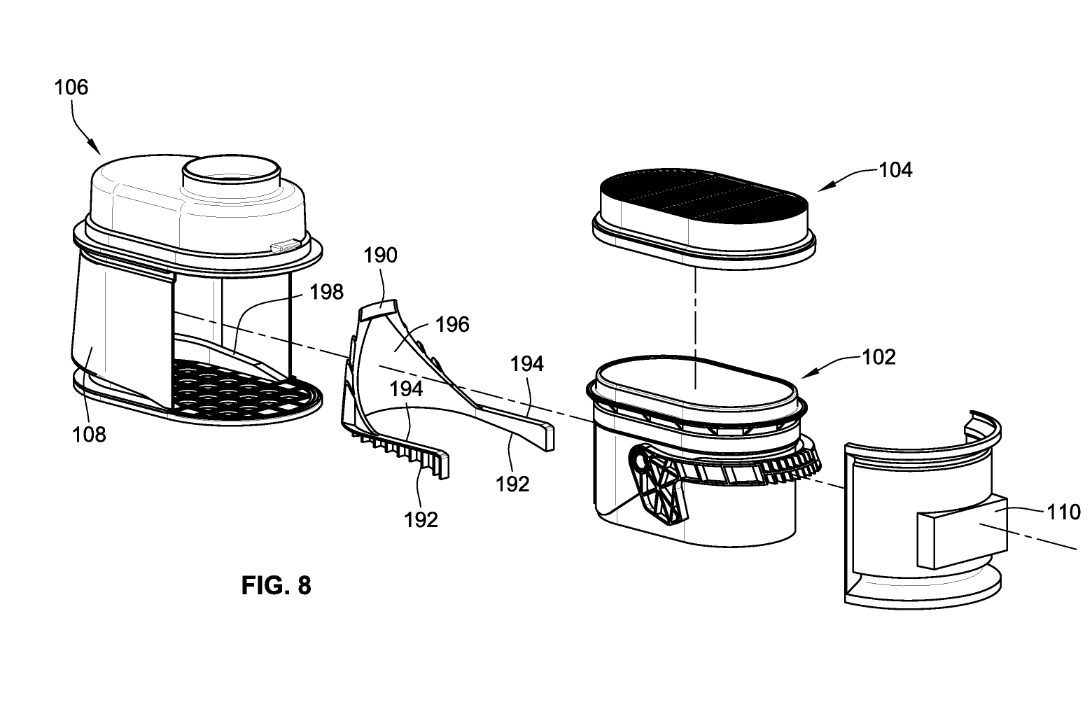

Turning now to FIGS. 8-17, the interrelationship between primary filter element 102 and secondary filter element 104 will be described in greater detail, particularly, a description will now be provided as to the seal formed between these elements as well as with housing 106. With specific reference to FIG. 8, housing 106 is illustrated as an existing side entry-type housing. To accommodate the seal assist functionality using handle 128 (See FIG. 2) of primary element 102, an insert 190 may be provided within the interior of housing body 108 of housing 106. Insert 190 is generally horseshoe-shaped, with two locking projections 192 extending outwardly from a connecting portion 196 as shown. Each locking projection 192 defines an upwardly facing locking surface 194. Insert 190 is shaped to sit on top of a housing ramp 198 formed within the interior of housing 108 as illustrated. As will be explained in greater detail below, by positioning insert 190 on top of housing ramp 198, locking surfaces 194 of locking projections 192 are brought into proximity with locking surfaces 136 of each locking projection 134 of handle 128 (See FIG. 2).

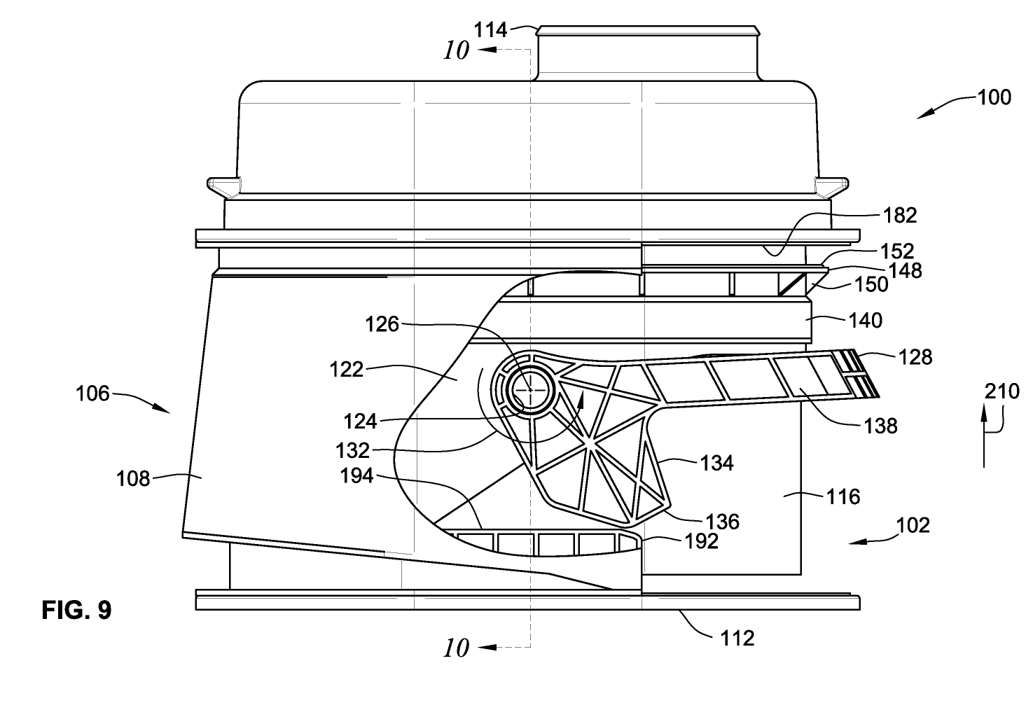

Turning now to FIG. 9, primary and secondary elements 102, 104 are situated within housing body 108 with primary element 102 shown in an unlocked position. In other words, handle 128 has been moved generally upward in linear direction 210 to rotate the same in the first rotational direction 132 about pivot 124. In this position, locking surface 136 of each locking projection 134 remains out of contact with locking surface 194 of projection 192 of insert 190. In this unlocked position, seat 148 remains axially out of contact with seal 182 of secondary filter element 104.

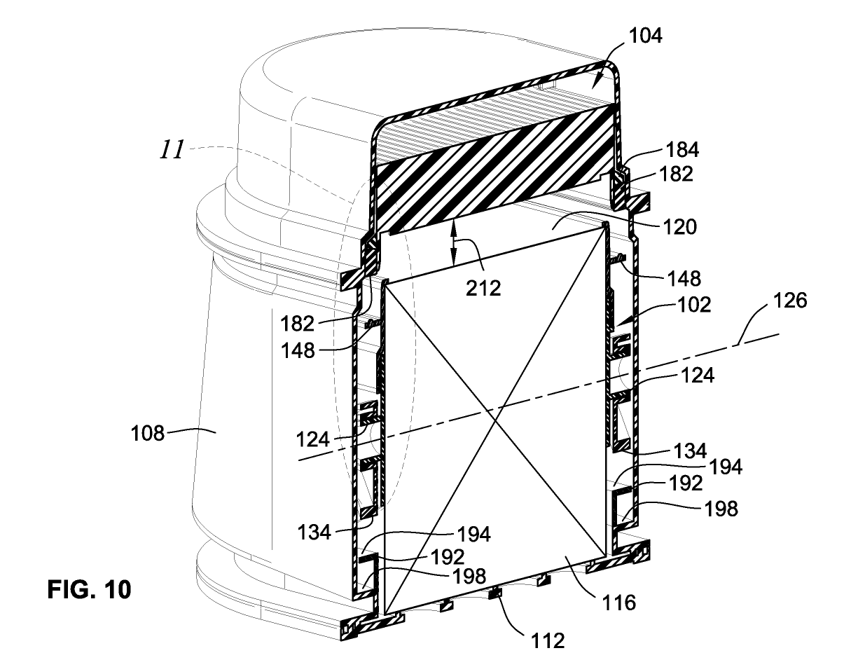

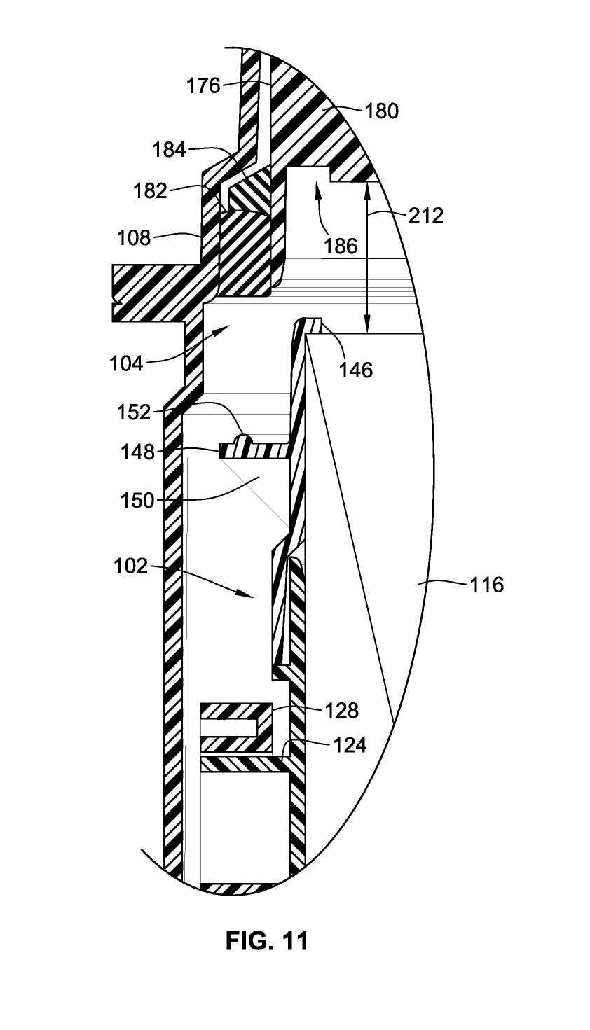

With reference to FIG. 10, in this unlocked position, an axial gap 212 is formed between primary filter element 102 and secondary filter element 104. As can also be seen in FIG. 10, secondary filter element 104, and more particularly seal 182 thereof, radially seals against an interior face of housing body 108. However, and because seat 148 is not seated against seal 182, fluid may short-circuit primary filter element 102 in this unlocked position. Indeed, as shown in FIG. 11, while a radial seal is formed between secondary filter element 104 and housing body 108, no seal is formed between primary filter element 102 and secondary filter element 104 in the unlocked position. Advantageously, secondary filter element 104 is relatively small when compared to primary filter element 102. Therefore, positioning secondary filter element 104, as well as forming a radial seal between secondary filter element 104 and housing body 108, is generally a simple process. Indeed, a user may simply load secondary filter element 104 into the interior of housing body 108 along first direction 96 (See FIG. 1), and then by hand situate secondary filter element 104 into the location illustrated in FIG. 11 by pushing the same by hand along second direction 98 (See FIG. 1). As will be described in greater detail below, thereafter, primary filter element 102 may then be inserted along first direction 96. To move primary filter element 102 along second direction 98, handle 128 (See FIG. 2) is utilized to bias seat 148 into contact with seal 182. Advantageously, the generally difficult movement along second direction 98 of primary filter element 102 is eliminated through the mechanical advantage provided by handle 128.

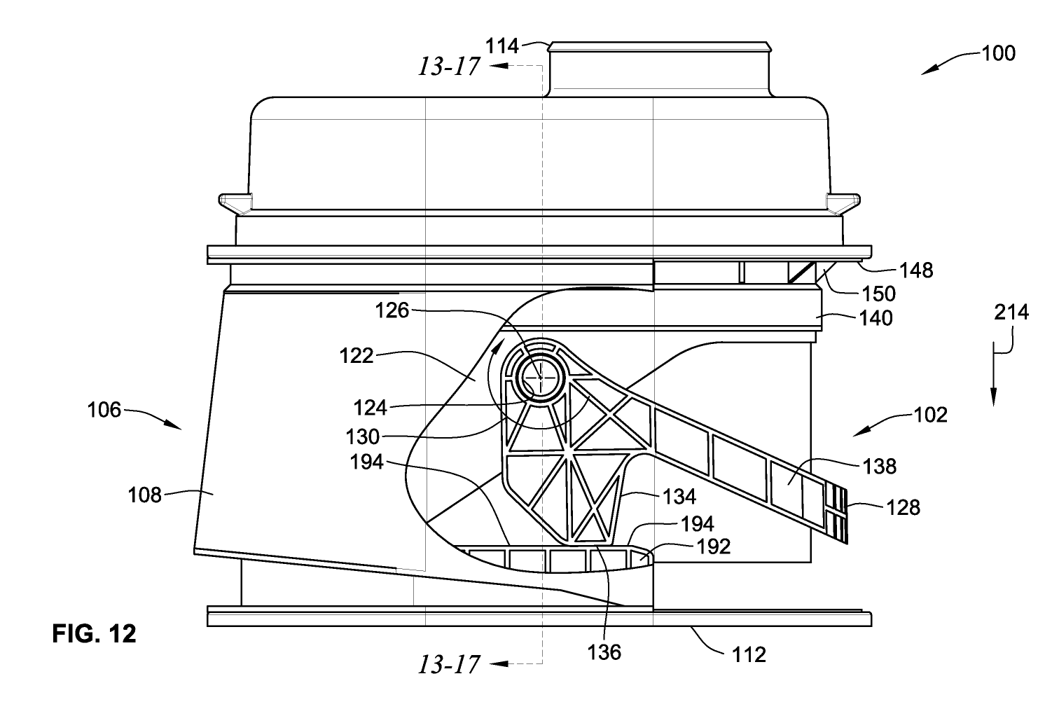

Indeed, and turning now to FIG. 12, primary filter element 102 is now illustrated in a locked position. To place primary filter element 102 in a locked position, handle 128 is moved generally downward along linear direction 214 such that the same rotates in the first rotational direction 130 about pivot 124. As locking projections 134 rotate in first rotational direction 130 about pivot 124, locking surfaces 136 of locking projections 134 axially engage locking surfaces 194 of locking projections 192 of insert 190. As a result, handle 128, and more specifically locking projections 134 thereof, are generally locked in an over-center orientation relative to pivot 124. Such engagement causes seat 148 to move axially upward to engage seal 182 as described below.

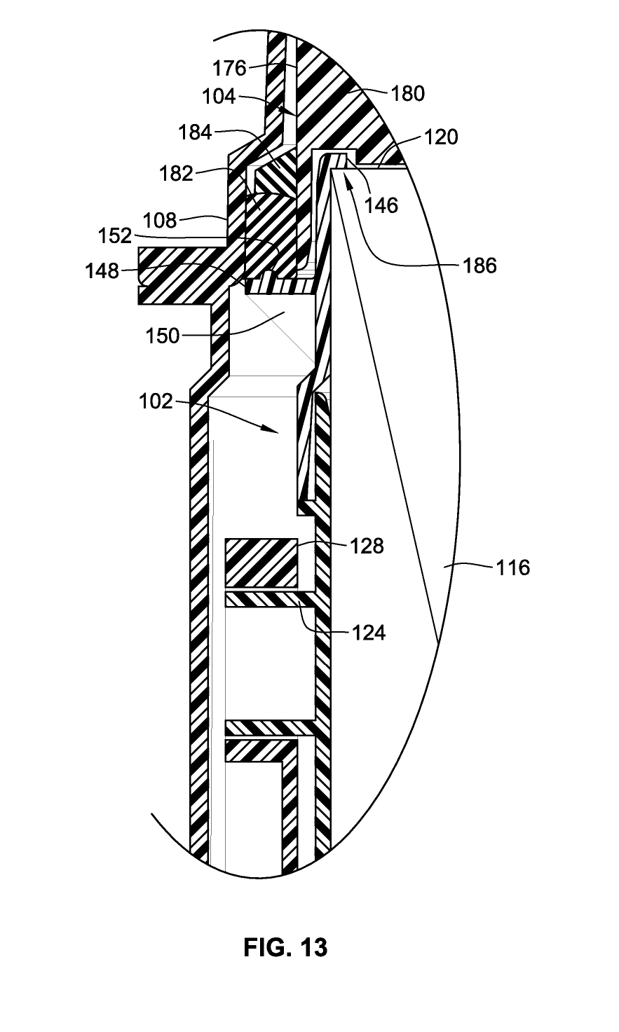

Indeed, and with reference now to FIG. 13, in the locked position, seat 148 is in axially abutted contact with seal 182. As a result, an axial seal is formed between primary filter element 102 and secondary filter element 104. Therefore, fluid must first be filtered through primary filter element 102 and then secondary filter element 104 as it passes between inlet 112 and outlet 114 of housing 106. (See also FIG. 1). This sealing contact between primary filter element 102 and secondary filter element 104 is easily achieved via use of handle 128 to place primary filter element 102 into a locked position.

Still referring to FIG. 13, in the locked position, lip 146 of frame 140 extends into notch 186 formed in dividers 180 as illustrated. As such, the outlet face 120 of filter media 116 is brought into close proximity with inlet face 172 (See FIG. 6) of secondary filter element 104.

To replace either of primary or secondary filter elements 102, 104, a reverse process is followed. Indeed, to place primary filter element 102 into an unlocked position so that it may be removed from housing body 108, a user simply moves handle 128 a linear direction 210 (See FIG. 9) so as to rotate handle 128 in the second rotational direction 132 about pivot 124. By doing so, locking surface 136 is brought out of axial contact with locking surface 194. By doing so, seat 148 moves axially away from seal 182. Thereafter, primary filter element 102 may be freely removed from housing body 108. A user may then replace primary filter element 102 with a new primary filter element 102, or alternatively, also remove secondary filter element 104 by hand by simply reaching inside housing body 108 to easily remove the same. Thereafter, secondary filter element 104 may also be replaced if necessary.

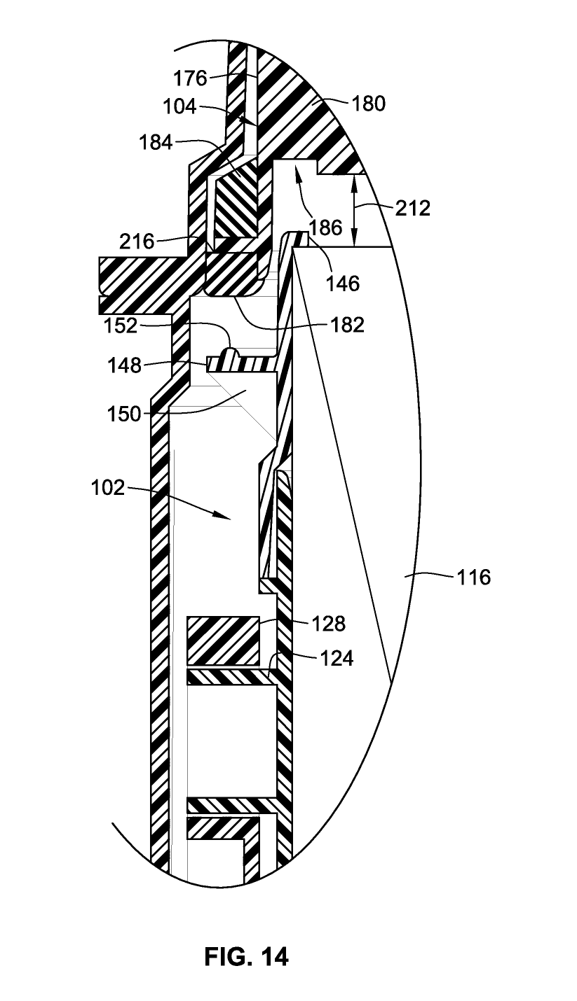

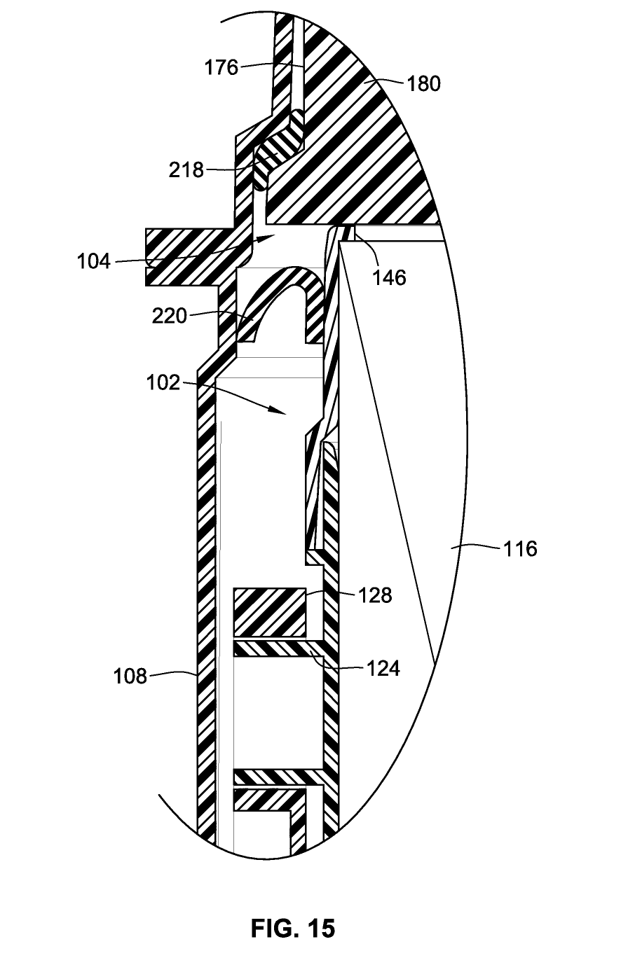

FIGS. 14-17 illustrate various alternative embodiments for seal configurations of primary and/or secondary filter elements 102, 104. With specific references to FIG. 14, frame 176 of secondary filter element 104 may also include a radial flange 216 projecting outwardly therefrom as illustrated. Seal support 184 may be positioned on one side of the radial flange 216, while seal 182 may be positioned on the other side of radial flange 216. It will be recognized that radial flange 216 provides additional axial reinforcement to seal 182. Turning now to FIG. 15, in another embodiment, primary filter element 102 may incorporate a wiper-type seal 220 as shown. Such a seal 220 is generally functionally the same as seal 182 and seat 148 described above in that it prevents fluid from short-circuiting primary filter element 102. A secondary seal 218 situated on frame 176 may also be provided to radially and/or axially seal secondary filter element 104 against housing body 108. Seal 220 may be a soft-felt material, or any other material sufficient to provide a sealing contact between primary filter element 102 and housing body 108.

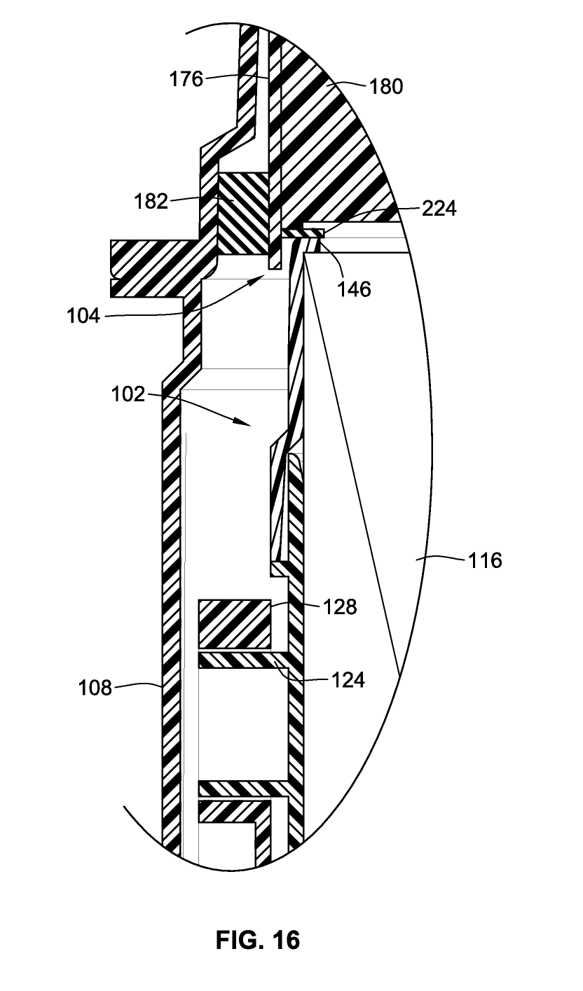

Turning now to FIG. 16, in yet another embodiment, a gasket-type seal 224 may be provided proximate width 146 of primary filter element 102. Seal 224 axially seals against frame 176 as shown. Secondary filter element 104 includes seal 182, and may also include seal support 184 although not shown, as described herein. Seal 182 forms a radial seal with housing body 108, while seal 224 forms an axial seal with secondary filter element 104. As a result, fluid cannot short-circuit either of primary or secondary filter elements 102, 104.

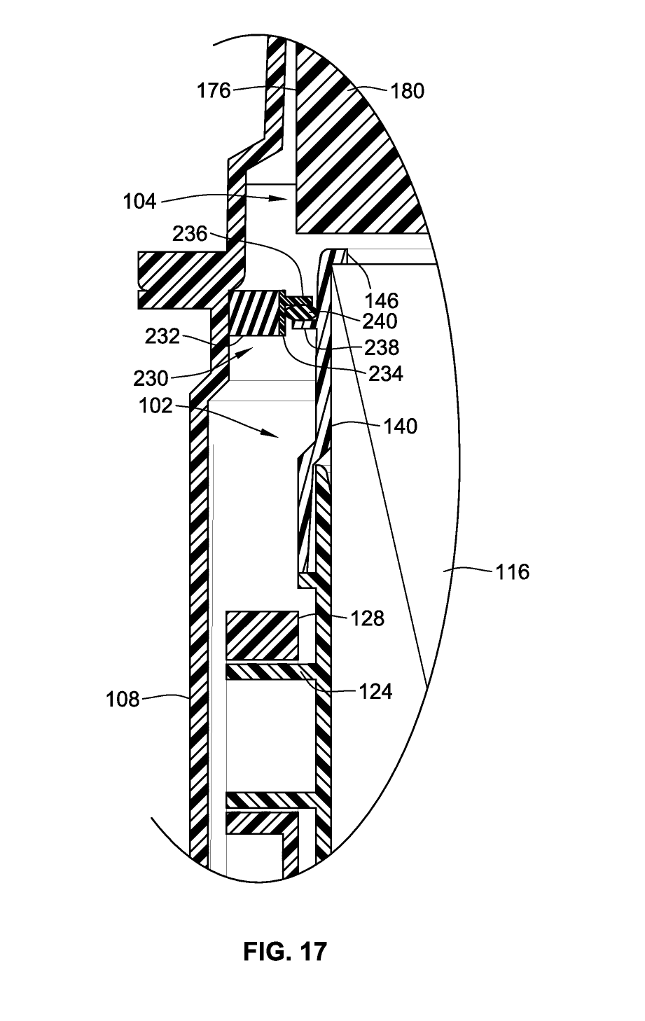

In another embodiment as shown in FIG. 17, secondary filter element 104 may omit a seal entirely. In the alternative, a seal ring insert 230 may be provided as shown. Seal ring insert 230 includes a housing seal 232 arranged forming a radial seal with housing body 108. Housing seal 232 is affixed to a ring member 234 of seal ring insert 230. Ring member 234 also includes a radially inwardly projected flange 236. A corresponding radially outwardly projecting flange 238 is formed on frame 140 of primary filter element 102. A seal 240 is positioned between flanges 236, 238 as shown. Seal 240 provides an axial seal between primary filter element 102 and seal ring insert 230. Seal 240 may be a stand along insertable seal ring, or alternatively, may be affixed to either of flanges 236 or 238. As a result of the axial seal provided by seal 240 and the radial seal provided by seal 232, fluid is prevented from short-circuiting either of primary or secondary filter elements 102, 104.

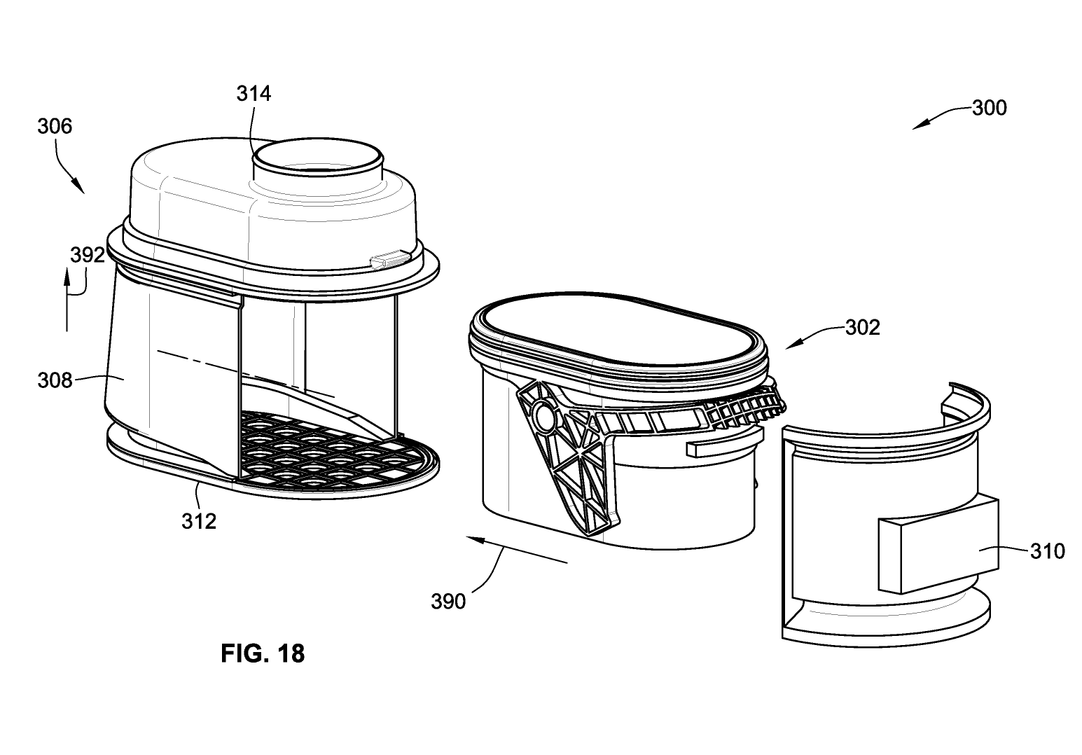

FIGS. 18-26 illustrate an alternative embodiment of a filter assembly 300. As will be discussed in greater detail below, in this embodiment, an insert 190 such as that illustrated at FIG. 8 is not required. Further, this embodiment is illustrated without a secondary filter element, although those skilled in the art will recognize a secondary filter element could easily be incorporated into filter assembly 300 without deviating from the teachings herein. Filter assembly 300 includes primary filter element 302 which is insertable into a housing 306, and more particularly a housing body 308 thereof, along a first direction 390. Once positioned within an interior of housing body 308, primary filter element 302 is then movable along second direction 392 to form a sealing contact between primary filter element 302 and housing body 308. Once primary filter element 302 is fully sealed within housing body 308, a cover 310 encloses primary filter element 302 such that flow through housing 306 is restricted to a flow path extending between inlet and outlet faces 312, 314 of housing 306.

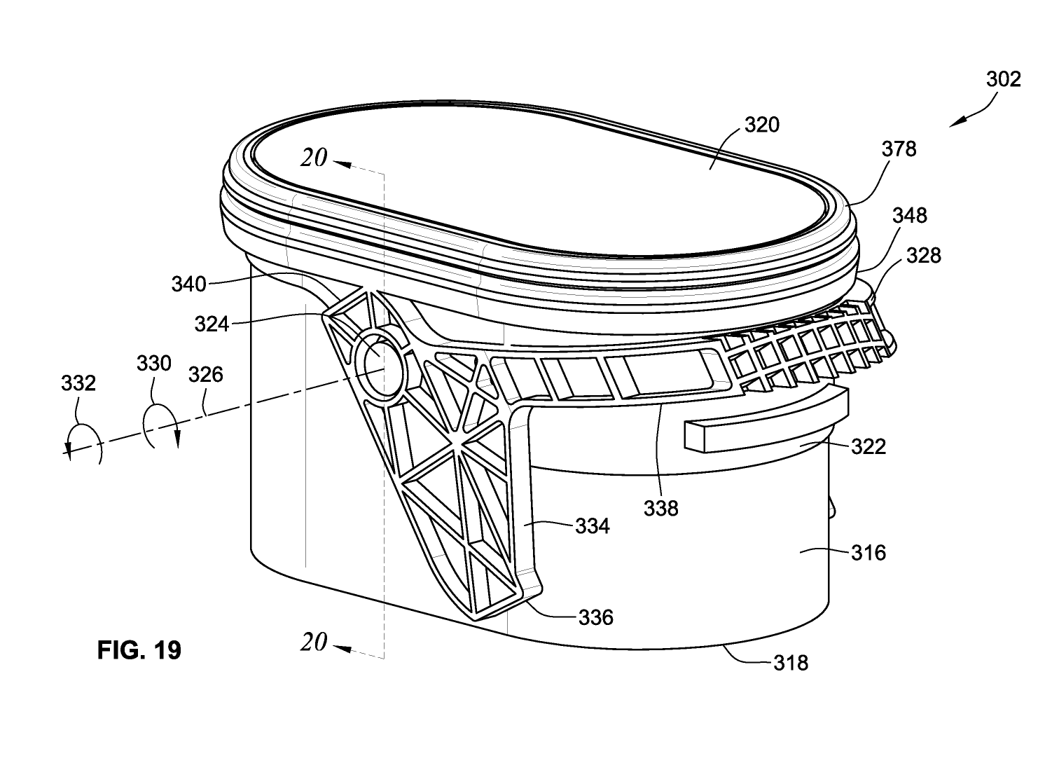

With reference now to FIG. 19, primary filter element 302 includes a block of filter media 316. Filter media 316 may be fluted filter media, pleated filter media, or any other suitable filter media, depending on the particular application of filter assembly 300. Filter media include an axial inlet face 318 and a corresponding axial outlet face 320 as shown.

A handle support 322 surrounds filter media 316. Handle support 322 provides a radially projecting pivot 324 which defines a pivot axis 326. A handle 328 is pivotable about pivot 324, and more particular pivot axis 326, in first and second rotational directions 330, 332 to transition primary filter element 302 between a locked and an unlocked position. The aperture formed on handle 328 which surrounds pivot 324 is generally over-sized to allow for planar movement of handle 328 relative to pivot 324.

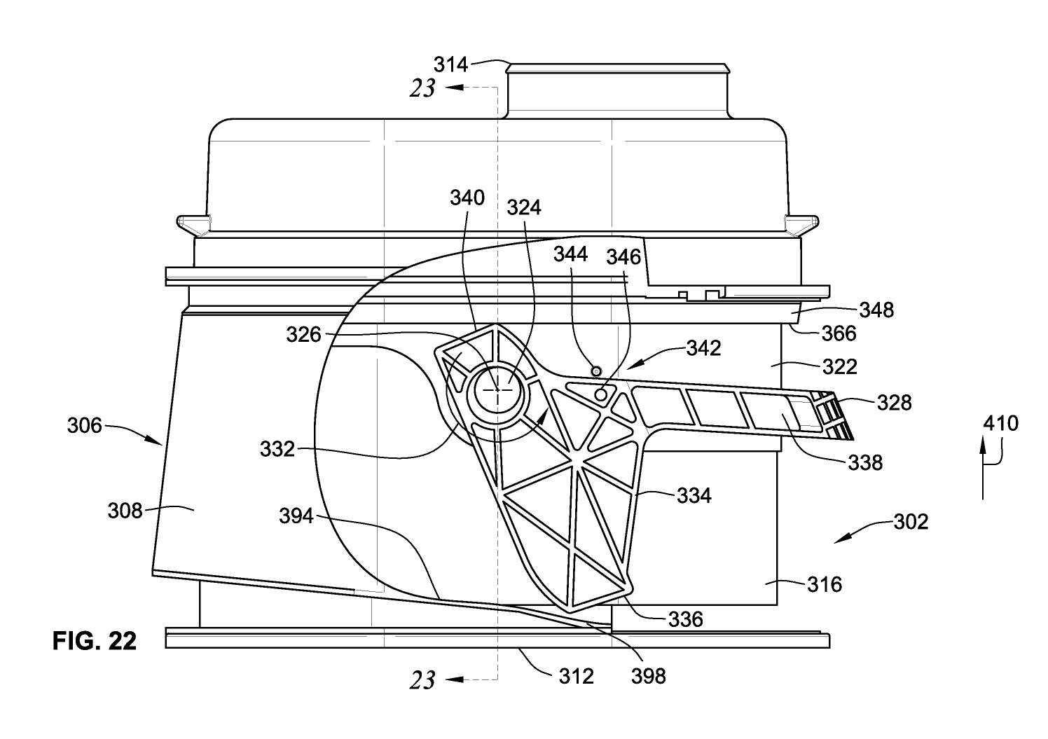

Additionally, a locking arrangement 342 is formed between handle support 322 and handle 328 as shown in FIG. 22. This locking arrangement 342 includes a detent 344 which extends from handle support 322, and an aperture 346 formed in handle 328. Detent 344 is resiliently positionable within aperture 346 to lock handle 328 in an unlocked position.

Handle 328 includes locking projections 334 on either side thereof, with only the left-most locking projection 334 shown in FIG. 19. A connecting portion 338 of handle 328 connects locking projections 334. Each locking projection includes a first locking surface 336 and a second locking surface 340 at opposed axially ends thereof. As will be described in greater detail below, locking surfaces 336, 340 engage housing 306, and a flange 348, respectively, when primary filter element 302 is in a locked position.

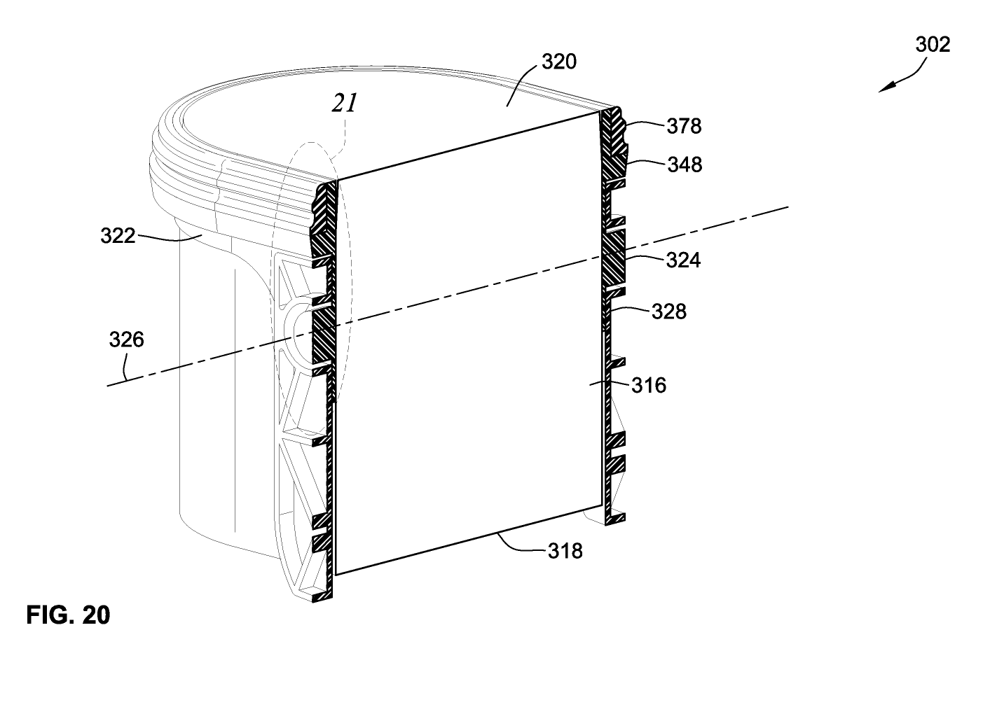

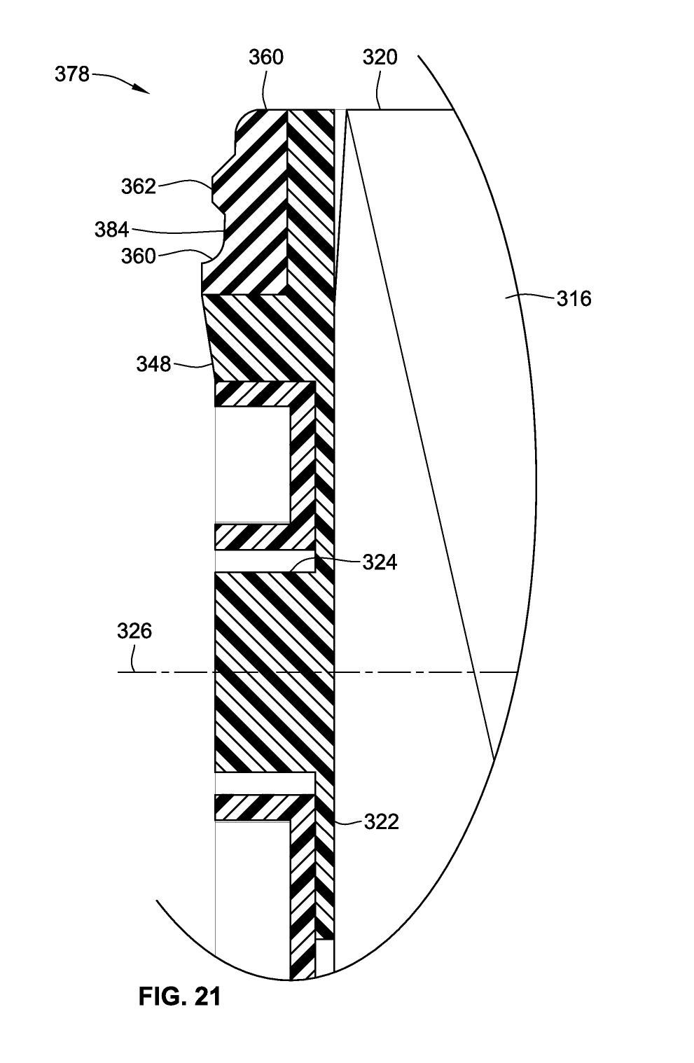

FIG. 20 illustrates primary filter element 302 in cross-section. Handle support 328 may be secured to media 316 via an adhesive or any other method used to secure a durable material to filter media. Handle support 328 includes a radially projecting flange 348 as shown. Flange 348 supports a seal arrangement 378. With reference to FIG. 21, seal arrangement 378 includes a seal 384. Seal 384 defines axial seal surfaces 360 and radial seal surfaces 362 as shown. Seal surfaces 360, 362 are used to form a seal between primary filter element 302 and housing body 308. Seal 384 may be a urethane or other resilient material. Further, although illustrated as formed of a single material, seal 384 may be formed from multiple materials having similar or dissimilar hardness ratings.

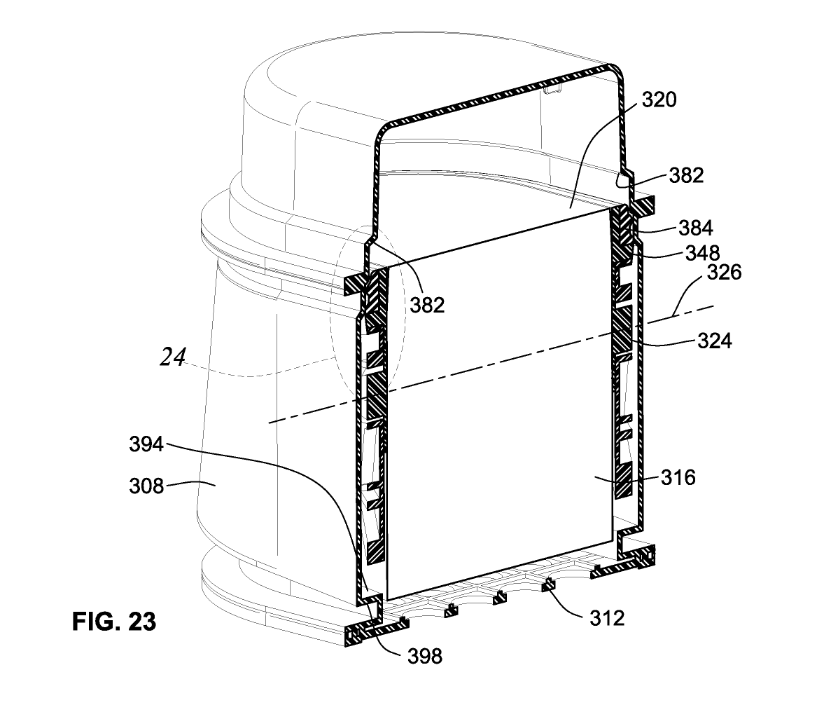

Turning now to FIG. 22, primary filter element 302 is positioned within housing 306 in an unlocked position. In the unlocked position, handle 328 has been moved upwardly along direction 410 to rotate handle 328 in second rotational direction 332 about pivot 324. In this configuration, locking surfaces 336, 340 are not in contact with any other surface. More particularly, the lower-most locking surface 336 remains out of contact with a locking surface 394 of a housing ramp 398 as shown. Similarly, the upper-most locking surface 340 remains out of contact with a locking surface 366 of flange 348. As can be seen in FIG. 23, in the unlocked position, seal 384 and its sealing surfaces 360, 362 remain generally out of contact with housing body 308.

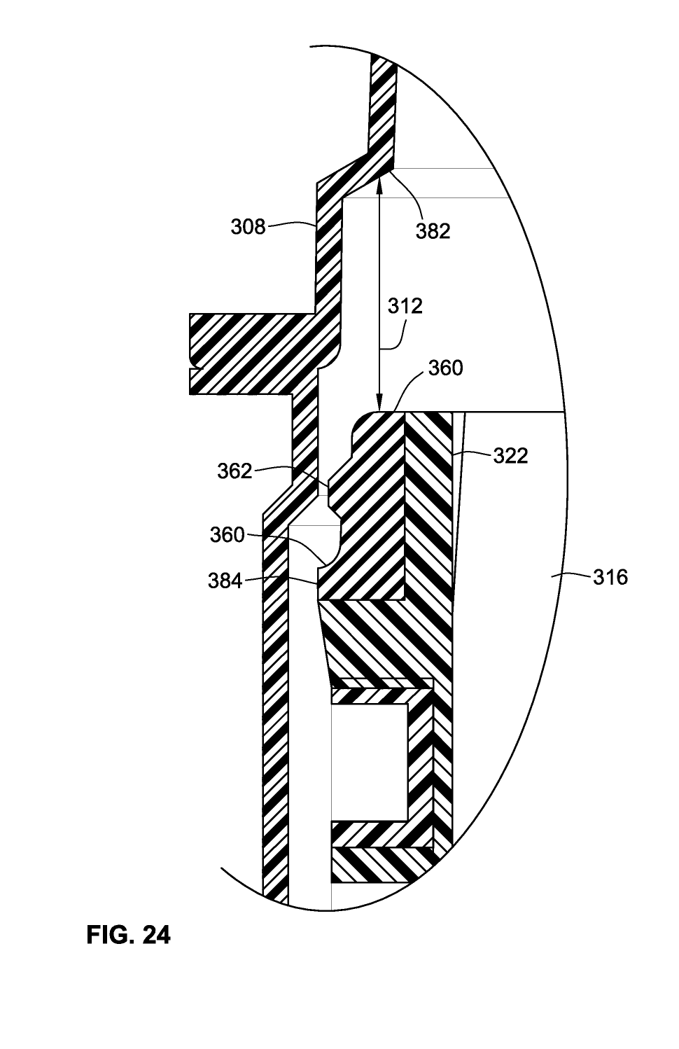

Indeed, and with reference now to FIG. 24, an axial gap 312 is formed between seal 384 and a seal surface 382 formed on housing body 308. However, when primary filter element 302 is transitioned into a locked position, the aforementioned axial gap 312 is eliminated as is described below.

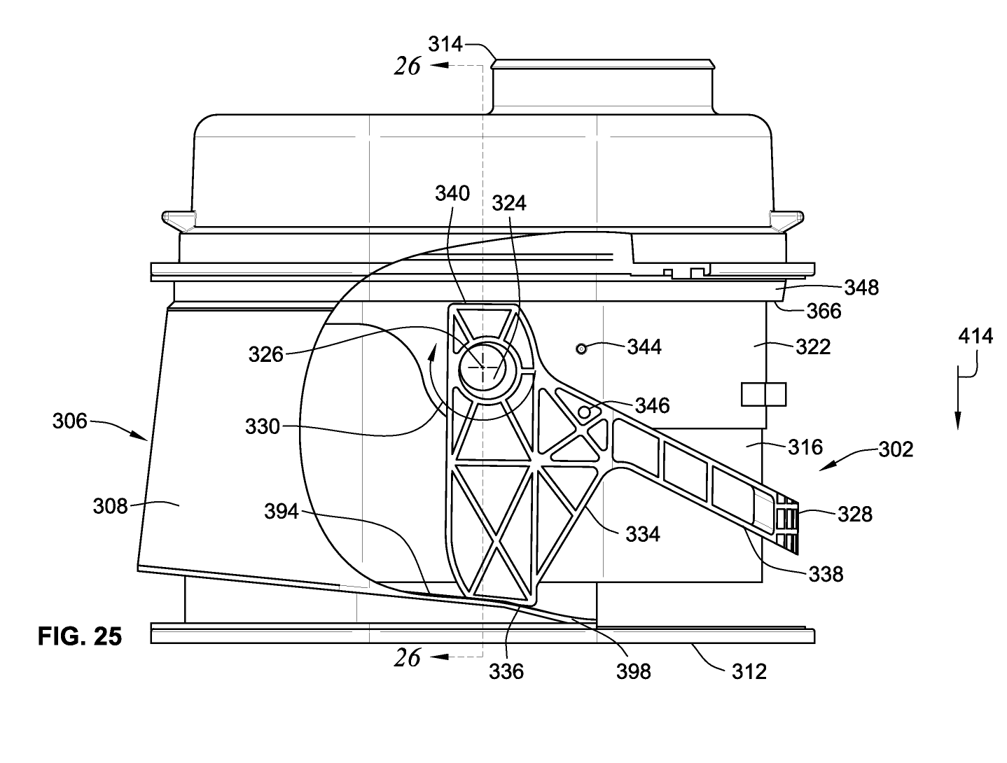

With reference now to FIG. 25, primary filter element 302 is illustrated in a locked position. To place primary filter element 302 in the locked position, handle 328 is moved generally downwards along direction 414 to rotate the same in the first rotational direction 330 about pivot 324. When this occurs, lower-most locking surface 336 engages locking surface 394 of housing ramp 398. Upper-most locking surface 340 engages locking surface 366 of flange 348 as shown. As a result, handle 328, and more particularly locking projections 334 thereof are locked in a generally over-center position. This causes primary filter element 302 to move axially upward and seal against housing body 308 as described below.

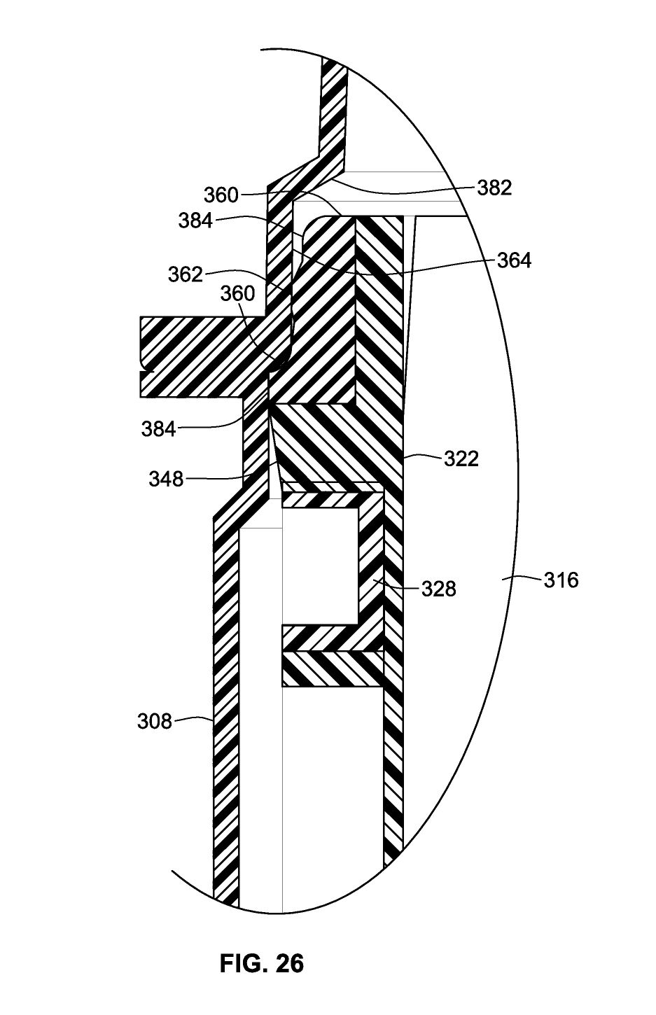

Indeed, as shown in FIG. 26, seal 384 has moved axially upward within housing body 308 such that lower-most axial seal surface 360 thereof abuts lower-most seal surface 382 of housing body 308. Also, radial seal surface 362 of seal 384 contacts a radial seal surface 364 of housing 308 as illustrated. Although upper-most axial seal surface 360 is not seated against upper-most axial seal surface 382 of housing body 308, those skilled in the art will recognize that the overall length of seal 384 could be increased to effectuate such a redundant axial seal. As described previously, this embodiment of filter assembly 300 thus does not include a secondary filter element. As such, all seals are effectuated by primary filter element 302. However, a secondary filter element could be utilized without deviating from the teachings herein.

The filter assembly described herein overcomes existing problems in the art by providing a side entry filter assembly design which facilitates low cost maintenance and ease of use by way of the mechanical advantage provided by a handle arrangement on a primary filter element. As such, the difficulties of installing a large primary filter element in a side entry-type housing are reduced or all together eliminated.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A side-entry filter assembly, comprising:
a housing defining a flow path extending between an inlet and an outlet of the housing;
a primary filter element positioned along the flow path, the primary filter element comprising a first filter media arrangement surrounded by a handle support, the handle support including at least one pivot defining a pivot axis, the primary filter element further comprising a handle rotatably connected at the at least one pivot, the handle pivotable about the pivot axis to place the primary filter element into a locked and an unlocked position;
a secondary filter element positioned along the flow path in series with the primary filter element, the secondary filter element comprising a second filter media arrangement surrounded by a frame; and
wherein in the locked positioned, the primary filter element sealingly engages the secondary filter element, and wherein in the unlocked position, the primary filter element does not sealingly engage the secondary filter element.

2. The filter assembly of claim 1, wherein the primary filter element further comprises a frame which surrounds the first filter media, the frame including a radially extending flange which defines a seat.

3. The filter assembly of claim 2, wherein the secondary filter element further comprises a frame surrounding the second filter media, the frame of the secondary filter element including a seal arrangement formed thereon.

4. The filter assembly of claim 3, wherein the seat axially engages the seal arrangement in the locked position.

5. The filter assembly of claim 4, wherein about 5 to about 15 pounds of force are required to place the primary filter element in the locked position.

6. The filter assembly of claim 2, wherein a portion of the frame of the primary filter element overlaps a portion of the handle support of the primary filter element, and is secured thereto.

7. The filter assembly of claim 1, wherein the primary filter element is free of a seal.

8. The filter assembly of claim 3, wherein the seal arrangement includes a seal extending axially beyond a lower most axial extent of the frame of the secondary filter element.

9. The filter assembly of claim 8, wherein the lower most axial extent of the frame of the secondary filter element is an over-compression limiter which prevents continued axial movement of the primary filter element toward the secondary filter element beyond a maximum position.

10. The filter assembly of claim 1, further comprising a housing insert having a generally horseshoe shape and providing a pair of upwardly facing locking surfaces, and wherein the handle includes a pair of locking projections having locking surfaces, wherein the upwardly facing locking surfaces of the housing insert axially engage the locking surfaces of the locking projections in the locked position.

11. A filter element, comprising:
a filter media arrangement having axial inlet and outlet faces;
a frame assembly at least partially surrounding the filter media arrangement, the frame assembly comprising a pair of pivots defining and commonly aligned along a pivot axis;
a handle pivotably attached to the frame assembly at the pivots; and
a radially extending flange extending outwardly from the frame assembly, the radially extending flange providing a seat for engaging a portion of a seal.

12. The filter element of claim 11, wherein the frame assembly includes a frame and a handle support, the frame attached to the filter media arrangement adjacent the axial outlet face thereof such that a portion of the frame extends radially inward and overlaps the axial outlet face.

13. The filter element of claim 12, wherein the frame extends radially away from an outer peripheral surface of the filter media arrangement to define an annular channel between the outer peripheral surface of the filter media arrangement and an inner peripheral surface of the frame.

14. The filter element of claim 13, wherein the frame assembly further comprises a handle support, wherein a portion of the handle support is disposed within the annular channel.

15. The filter element of claim 11, wherein the handle includes a pair of locking projections each of which defines a locking surface disposed below the pivots.

16. The filter element of claim 15, wherein the frame assembly comprises a handle support, and wherein the pivots extend radially outwardly therefrom, wherein the pair of locking projections further comprise secondary locking surfaces in opposed spaced relation to the locking surface, the secondary locking surfaces disposed above the pivots.

17. A method for servicing a side-entry filter assembly, comprising:
removing an existing primary filter element from a housing;
removing an existing secondary filter element from the housing;
installing a new secondary filter element having a seal arrangement for sealingly engaging the housing;
installing a new primary filter element having a seat and a biasing arrangement into the housing; and
biasing the seat, using the biasing arrangement, into axial sealing engagement with the seal arrangement.

18. The method of claim 17, wherein the step of installing the new secondary element includes inserting the secondary element along a first axis of insertion into the housing, and thereafter moving the secondary filter element along a second axis of insertion perpendicular to the first axis of insertion.

19. The method of claim 18, wherein the step of installing the new primary filter element includes inserting the primary filter element into the housing along the first axis of insertion axially below the secondary filter element.

20. The method of 19, wherein the step of biasing the seat includes biasing the seat with a handle operably connected to the primary filter element to selectively place the primary filter element in a locked and an unlocked position.
